(19) United States
(12) Patent Application Publication
(10) Pub. No.: US 2008/0196161 A1
(43) Pub. Date: Aug. 21, 2008

(54) Flexible Bathtub Waste Pipe Assembly for Bathtubs and the Like

(75) Inventor: William T. Ball, Colorado Springs, CO (US)

Correspondence Address: SHERIDAN ROSS PC, 1560 BROADWAY, SUITE 1200, DENVER, CO, 80202, US

(73) Assignee: WCM Industries, INC., Colorado Springs, CO (US)

(21) Appl. No.: 12/100,762

(22) Filed: Apr. 10, 2008

Related U.S. Application Data
(63) Continuation-in-part of application No. 10/971,895, filed on Oct. 22, 2004, now abandoned.

(51) Int. Cl. E03C 1/24; F16L 11/00

(52) U.S. Cl. 4/680; 138/118

(57) ABSTRACT

A bathtub waste pipe assembly for draining fluid from a bathtub where the bathtub has an upper overflow drain and a lower drain. The bathtub waste pipe assembly includes a flexible hollow pipe extending from the upper overflow drain to the lower drain.

This application is a Continuation-In-Part of pending U.S. patent application Ser. No. 10/971,895, filed Oct. 22, 2004, the entire disclosure of which is incorporated by reference herein.

This application is also related to U.S. patent application Ser. No. 10/732,726, filed Dec. 10, 2003, U.S. Patent Application Publication No. 2004/0117907, which is a Continuation-In-Part of U.S. patent application Ser. No. 09/954,420, now U.S. Pat. No. 6,691,411, filed Sep. 17, 2001 and a Continuation-In-Part of U.S. patent application Ser. No. 10/229,533, now U.S. Pat. No. 6,675,406, filed Aug. 28, 2002, the latter being a Continuation of abandoned U.S. patent application Ser. No. 09/953,724, filed Jun. 13, 2000, the entire disclosures of which are incorporated by reference herein.

This application is also related to U.S. patent application Ser. No. 10/674,862, U.S. Patent Application Publication No. 2004/0068793, filed Sep. 30, 2003, which is a Continuation-In-Part of U.S. patent application Ser. No. 10/229,533, filed Aug. 28, 2002, now U.S. Pat. No. 6,675,406 and a Continuation-In-Part of U.S. patent application Ser. No. 10/222,062, now U.S. Pat. No. 6,637,050, filed Aug. 16, 2002, the entire disclosures of which are incorporated by reference herein.

### FIELD OF THE INVENTION

Embodiments of the present invention are generally related to waste water plumbing assemblies for interconnection to a bathtub, shower, sink, etc. More specifically, one embodiment of the present invention employs a flexible pipe, thereby accommodating plumbing and bathtub misalignments.

### BACKGROUND OF THE INVENTION

In plumbing of bathtubs, existing rigid waste pipe assemblies are used to receive the effluent or overflow fluid from the bathtub. Rigid pipes are often difficult to install in the tight spaces about a bathtub. Further, rigid pipes need to either be properly sized in length, or retrimmed to a proper length prior to installation to the bathtub. Additionally, plumbing assemblies comprising rigid pipes include a multiplicity of pieces, which adds to the cost and complexity of assembly. More specifically, often misalignments exist between bathtubs and the existing plumbing systems of a house. These anomalies are discovered during installation and increase the difficulty of interconnecting a bathtub drain port and bathtub overflow port to an inlet of the main waste water drainpipe of a plumbing system. Accordingly, contractors must accommodate misalignments by adding elbows or other devices to connect the bathtub to the plumbing system. The attachment of elbows is not only difficult, due to confined working spaces, but also increases the likelihood of leaks. More specifically, the more joints in a plumbing system, the higher the probability leaks may occur in one or more of the joints. If a leak is found during testing, for example, it is difficult to regain access to the overflow and drain assemblies to make repairs.

Thus, there is a long felt need in the field of plumbing to provide an assembly and method for accommodating misalignments between the bathtub and the plumbing system of a dwelling that takes into account misalignments often found between the plumbing system and the bathtub. The following disclosure describes an improved system and method that utilizes flexible hoses for interconnecting drain assemblies and overflow assemblies of a bathtub to the plumbing system of a house.

### SUMMARY OF THE INVENTION

It is one aspect of the present invention to provide a system that facilitates the installation of a bathtub to a plumbing system. More specifically, instead of utilizing rigid pipes to direct fluid from an overflow assembly and/or the drain assembly of a bathtub, embodiments of the present invention employ flexible pipes. One embodiment of the present invention, preferably employs a flexible pipe that connects the overflow assembly of a bathtub to a tee connector. Yet another flexible pipe is employed between the drain and the tee connector. The tee connector is also interconnected to a rigid main waste pipe of the plumbing system. Another embodiment of the present invention provides a single flexible hose wherein the tee connector is directly interconnected to the drain assembly of a bathtub, for example. In such embodiment, the tee connector is also interconnected to the main drain pipe of the plumbing assembly.

It is another aspect of the present invention to provide a system and method that can be selectively customized during installation. More specifically, it is contemplated that the flexible portions of the pipes described herein may be cut to length as needed. Often, as one skilled in the art will appreciate, plumbing systems are not perfectly aligned with the overflow and/or drain ports of a bathtub. In the past, a plumbing contractor would be required to alter the plumbing system to account for the misalignment, an expensive and time consuming undertaking. Alternatively, expensive modifications related to the installation of the bathtub, sink, etc. would have to be performed. Some plumbing contractors simply exert undesired force to move parts into alignment, which stresses the rigid pipes and makes them susceptible to leaking, breakage, etc. Thus, embodiments of the present invention provide a system wherein flexible pipes are provided that may be adjusted to a preferred size (e.g. by cutting) and selectively bent to accommodate misalignments. This aspect of the present invention is desirable because the addition of multiple elbows is not required. The addition of multiple elbows not only increases the chances for leaks, but also creates a complicated flow path for drainage water that can add to the instances of clogging. As will be apparent to one skilled in the art, the robustness offered by the present invention enables vertical and/or horizontal adjustments in a superior manner, as compared to prior art systems and methods.

Yet another aspect of the present invention is to provide a system and method that can be installed on virtually any type of bathtub. More specifically, the horizontal and/or vertical distances between the drain port and the overflow port can vary from bathtub to bathtub. The robustness provided by the flexible overflow and/or drain pipes of the present invention, and the ability to customize the same, allows for desired accommodation for bathtubs of various type/design. Thus, contractors no longer need to customize a plurality of rigid tubes since embodiments of the present invention allow for easy cutting and modifying of flexible tubes to meet their requirements.

It is another aspect of the present invention to provide a system and method that can be used with common overflow and drain assemblies. More specifically, one embodiment of the present invention is used in conjunction with the overflow assembly described in the U.S. patents and patent applications listed herein. The flexible pipes described herein are also adapted to be used with drain assemblies provided in U.S. Patent Application Publication Nos. 20070044230, 2006009019, and 20060096018 and U.S. Pat. Nos. 6,317,906, 6,173,459, 6,640,358, 6,418,570, 6,691,411 and 6,546,573, the entire disclosures of which are incorporated by reference herein. Embodiments of the present invention have the ability to be bonded or otherwise interconnected easily to overflow assemblies and drain assemblies shown and referred to herein, or to other commonly used overflow and/or drain assemblies.

Thus, it is a related aspect of the present invention to provide a kit to be used by plumbing contractors. More specifically, it is contemplated that a kit containing overflow assemblies, drain assemblies, finishing hardware, etc. may be supplied in a single package that includes flexible pipes. Further, it is contemplated that such flexible pipes may be provided in lengths that are purposely longer than required to enable a contractor the ability to trim the flexible pipes as needed or desired.

It is yet another aspect of the present invention to provide flexible pipe sections that employs a generally smooth inner surface. More specifically, although certain types of flexible pipes are generally well known, flexible pipes of the prior art often employ bellows that have internally and externally disposed corrugations. Although such a configuration is acceptable in some arenas, in the plumbing art it often is not. More specifically, internally disposed corrugations are apt to retain fluids and/or debris from the bathtub, such as hair, dirt, skin etc. This debris and related fluid may be a breeding ground for germs, bacteria and mold. Thus building codes often require that drain pipes must be generally smooth to provide laminar flow that facilitates the drainage of all fluid from the bathtub and associated pipes.

It is another aspect of the present invention to provide a flexible pipe of various lengths, diameters and wall thicknesses that may be used in various other applications. More specifically, many non-plumbing related applications use flexible tubes, pipes, conduits. For example, in aerospace, flexible tubes are used to provide purge gases and fluids. Thus, the flexible pipes described herein may be scaled in size to accommodate such applications as found in aerospace, or applications directed to HVAC, wherein such flexibility, absence of rough surfaces, etc. is useful and long sought.

The Summary of the Invention is neither intended nor should it be construed as being representative of the full extent and scope of the present invention. The present invention is set forth in various levels of detail in the Summary of the Invention, as well as in the attached drawings and the Detailed Description of the Invention, and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a side cross-sectional view of a bathtub of the prior art employing a rigid waste pipe assembly;

FIG. 2 is a side elevation view of one embodiment of the present invention associated with a bathtub;

FIG. 3 is a perspective view of another embodiment of the present invention;

FIG. 4 is a side elevation view of an embodiment of the invention shown in FIG. 3 associated with a bathtub;

FIG. 5 is a side elevation view of another embodiment of the invention associated with a bathtub; and

FIG. 6 is a partial cross-section of a flexible pipe of one embodiment of the present invention.

To assist in the understanding of the present invention the following list of components and associated numbering found in the drawings is provided herein:

| # | Components |
|---|---|
| 2 | Plumbing system |
| 6 | Bathtub |
| 10 | Overflow assembly |
| 14 | Flange |
| 18 | Overflow port |
| 22 | Overflow elbow |
| 26 | Vertical drain pipe |
| 30 | Drain assembly |
| 34 | Drain elbow |
| 38 | Flange |
| 42 | Outer surface |
| 46 | Drain port |
| 50 | Horizontal drain pipe |
| 54 | Tee connector |
| 58 | Main drain pipe |
| 62 | Flexible pipe |
| 62V | Vertical flexible waste water pipe |
| 62H | Horizontal flexible waste water pipe |
| 66 | Coil |
| 72 | Flexible material |
| 76 | Flexible waste water pipe assembly |
| 80 | Diaphragm |
| 84 | Web |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

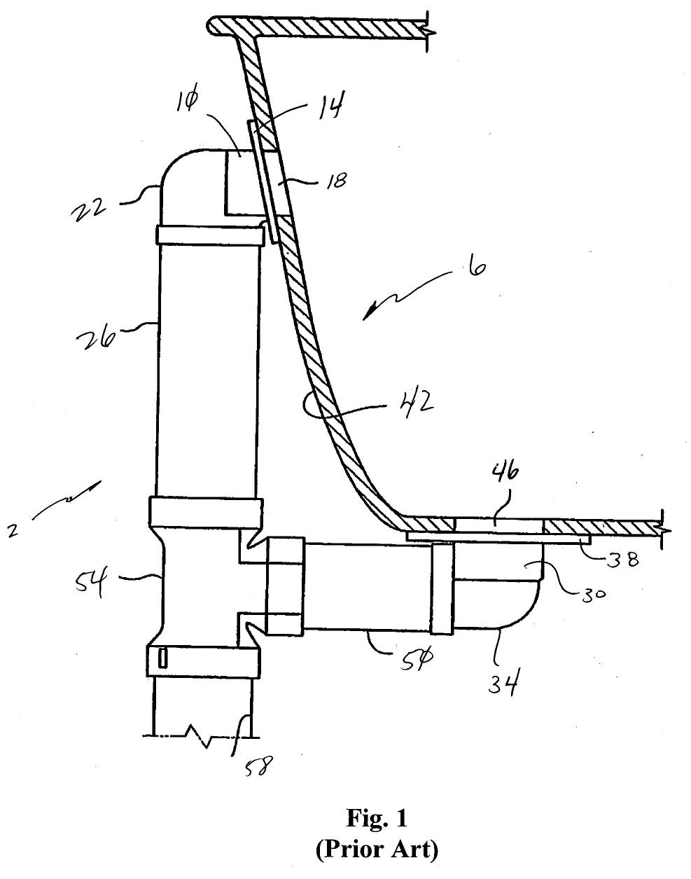

Referring now to FIG. 1, a prior art method of interconnecting a plumbing system 2 to a bathtub 6 is shown. Here, an overflow assembly 10 having a flange 14 is shown interconnected to the bathtub 6 and placed in fluidic communication with an overflow port 18 of the bathtub 6. The overflow assembly 10 includes an overflow pipe 22 that is interconnected to a rigid vertical pipe 26. Similarly, the drain assembly 30, which includes a drain elbow 34 with a flange 38 that places the drain assembly 30 adjacent to the outer surface 42 of the bathtub 6, is placed in fluidic communication with a drainport 46 of a bathtub 6. The drain assembly 30 is interconnected to a rigid horizontal pipe 50. The rigid vertical pipe 26 and the rigid horizontal pipe 50 are interconnected to a tee connector 54 that is also interconnected to a main drain pipe 58 of the plumbing system 2. As it will be appreciated by those skilled in the art upon review of FIG. 1, vertical and horizontal misalignments parallel with the page and perpendicular to the page, will require adjustments in the location of a tee connector 54 and/or the main drain pipe 58. Alternatively, additional pipes and elbows will be required to accommodate the misalignment or to assemble around house framing, support, and/or other necessary building structures.

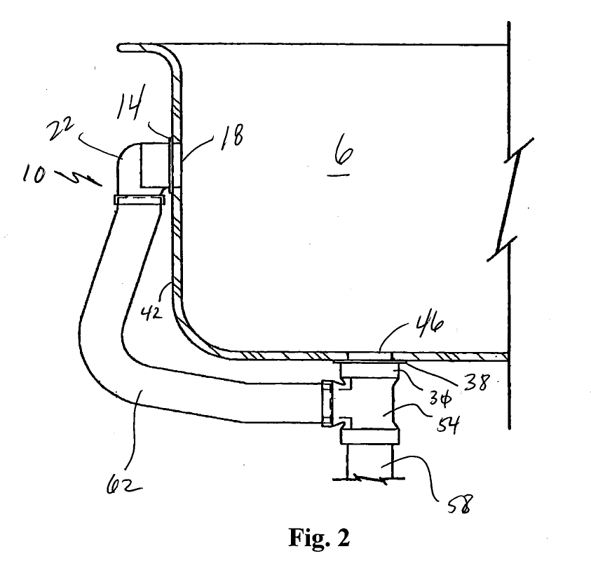

Referring now to FIGS. 2-6, embodiments of the present invention are provided that employ a bendable fluid conduit, such as a flexible waste water pipe 62. One embodiment of the present invention employs a single flexible waste water pipe 62 that interconnects the overflow assembly 10 to the tee connector 54. The tee connector 54, in turn, is interconnected directly to the drain assembly 30 and the main drain pipe 58 of the plumbing system. Another embodiment of the present invention utilizes two flexible pipes, the first being interconnected from the overflow assembly 10 to the tee connector 54 and the second being interconnected from the drain assembly 30 to the tee connector 54. Again, the tee connector 54 is placed in fluidic communication with a main drain pipe 58 of the plumbing system. Both of such embodiments of the present invention, and those similar thereto, employ a flexible pipe having a generally smooth inner surface. More specifically, the flexible pipe 62 of one embodiment employs a coiled member 66 that is enveloped by a layer of flexible material 72, such as rubber. This construction provides a generally smooth inner surface and the ability to flex within a given range, without undesired crimping or other deformities that cause structural integrity issues.

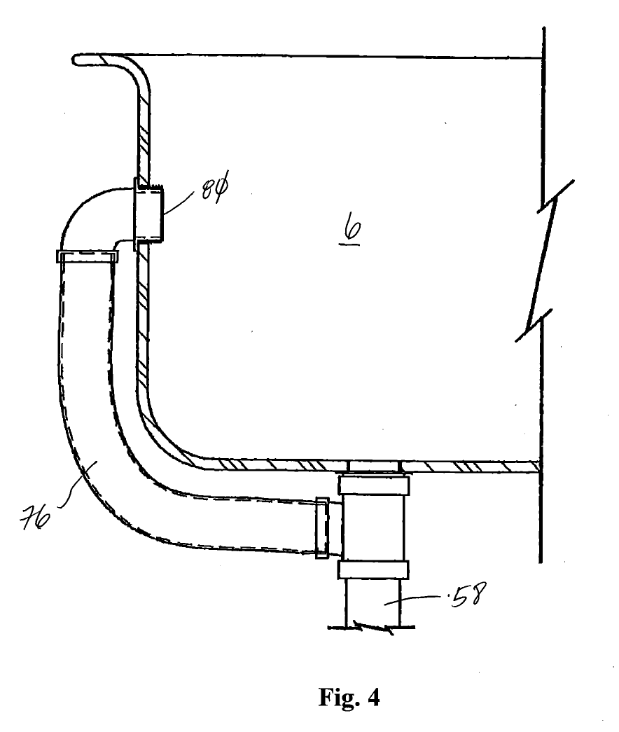

Referring now to FIGS. 2-4, one embodiment of the present invention is shown that employs a single flexible waste water pipe 62 that is interconnected between the overflow assembly 10 to the tee connector 54. The tee connector 54 is also associated with the bathtub 6, for example with the drain assembly 30. Here, overflow water is able to transition from the overflow port 18 of the bathtub 6 through the flexible waste water pipe 62 into the tee connector 54 and to the main drain 58. Similarly, drain water from the bathtub 6 flows through the drain port 46 into the tee connector 54 and out the main drain 58. FIG. 4, which is similar to FIG. 2, illustrates that the flexible waste water pipe 62 may be fabricated in a single assembly 76 as opposed to a flexible waste water pipe that is interconnected to an existing tee and overflow port. Here, the assembly 76 may be customized for a specific bathtub, and main drain pipe combination. The overflow assembly 10 employed may have a diaphragm 80 to facilitate testing.

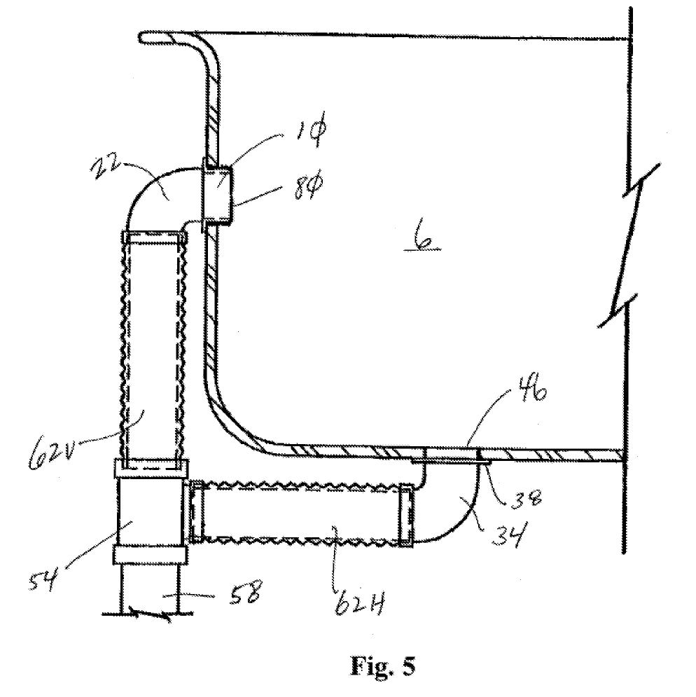

Referring now to FIG. 5, yet another embodiment of the present invention is provided wherein two waste water pipes 62 are used. Here a vertical flexible waste water pipe 62V interconnects the overflow assembly 10 to the tee connector 54. In addition, a horizontal flexible waste water pipe 62H is interconnected between the drain assembly 30 to tee connector 54. The tee connector 54 is also interconnected to the main drain 58. As in other embodiments, this embodiment may include a diaphragm 80 interconnected to the overflow assembly 10 as succinctly described in some of the above-identified U.S. patents incorporated for such purposes by this reference. The vertical flexible waste water pipe 62V and the horizontal flexible waste water pipe 62H of this embodiment of the present invention may be interconnected rigidly to at least one of the drain assembly 30, overflow assembly 10 and/or the tee connector 54. However, it is also contemplated that the vertical flexible waste water pipe 62V and the horizontal flexible waste water pipe 62H be such that they can be selectively altered and customized (e.g. cut to a desired length, angle, associated with other components, etc.) and then interconnected to the overflow assembly 10, the drain assembly 30, the tee connector 54, for example.

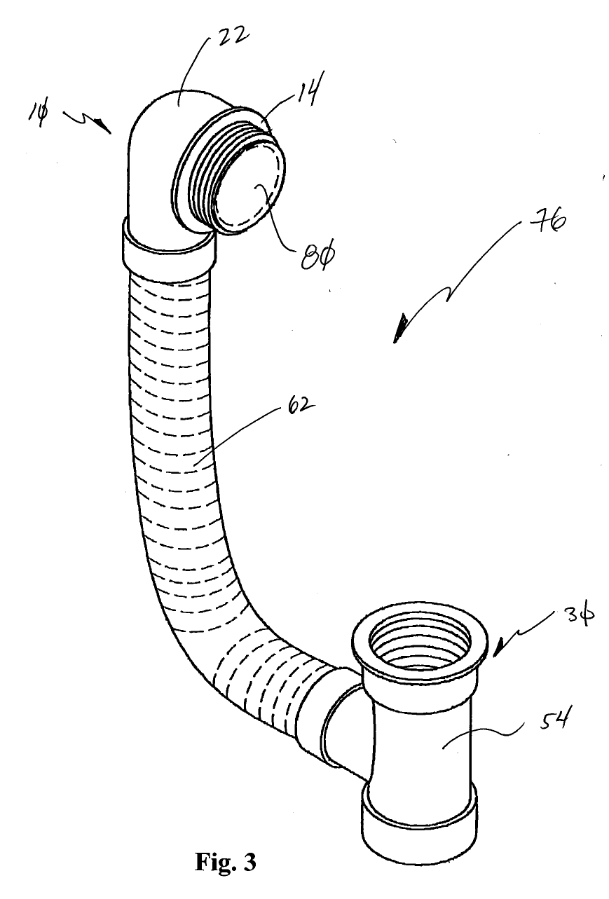

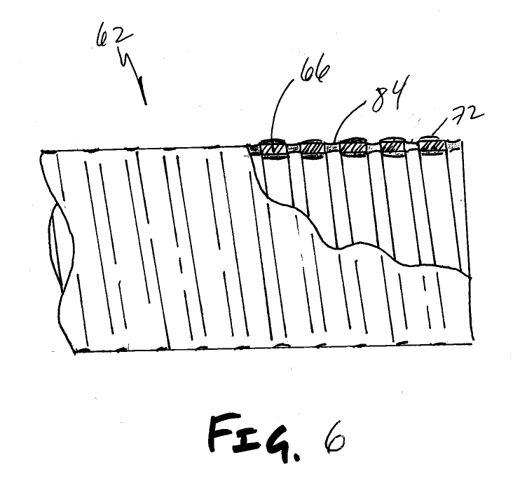

Referring now to FIGS. 3 and 6, the flexible pipe 62 of one embodiment of the present invention is provided. Embodiments of the present invention employ a ribbed, bellowed, or coiled 66 structure of rigid material that is apt to bend due to its coiled arrangement. In one embodiment the ribbed or coiled material is sufficiently rigid to retain a substantially circular cross section, thus providing a substantially uniform flow path for liquid transportation through the interior of such ribbed, bellowed or coiled structure. In certain embodiments the ribbed/bellowed/coiled material employed is different that the material comprising the remainder of the conduit/pipe formed. For example, a more pliable material may be to coat the ribbed/bellowed/coiled material.

In order to provide a flow path for fluid, the rigid material is coated with a flexible material 72 that is, preferably, substantially kink resistant. Thus between portions of the coil a web 84 will exist. In one embodiment such web material, when combined with the coiled substructure is not completely smooth. In other embodiments, this web/coil combination provides a substantially smooth flowpath that is not apt to trap debris or water. In addition, the coil/flexible material combination is tightly bonded yet easy to cut, thereby facilitating customization of embodiments of the present invention. Those skilled in the art will appreciate that instead of a coil 66, a plurality of spaced rings may be employed that are also coated with a flexible material 72. Other methods for making the structure as disclosed will be obvious to one skilled in the art. Certain embodiments of the present invention employ plastic (such as PVC) as the flexible material 72 and plastic (such as PVC) as the material for the coil 66. However, those skilled in the art will appreciate that other flexible materials such as rubber, acrylonitrile butadiene styrene (ABS), polycarbonate, polypropylene, and nylons, to name a few, may be employed without departing from the scope of the invention. The coil system may be made of a metallic material, PVC, carbon fiber, reinforced nylons, hard durometer rubbers, to name a few, without departing from the scope of the invention.

Referring now to FIGS. 2-6, a method of installing the embodiments of the present invention is provided. In one embodiment of the present invention, a single flexible waste water pipe 62 is employed. As such, an installer interconnects one end of the flexible waste water pipe 62 to the overflow assembly 10 and then interconnects the overflow assembly 10 to the bathtub 6. The other end of the flexible waste water pipe 62 is interconnected to the tee connector 54 that interconnects the drain assembly 30 to the main drain 58.

Alternatively, with reference to FIG. 3, the flexible assembly waste water pipe 62 may be provided with a rigidly interconnected overflow assembly 60 and tee connector 54. This method of interconnection allows for quick installation of the overflow assembly 10 and the tee connector 54 to the drain assembly 30 of the bathtub 6, while providing flexibility to accommodate misalignments.

Referring now to FIG. 5, another embodiment of the present invention as described above, employs a vertical flexible waste water pipe 62V and a horizontal flexible waste water pipe 62H. Again, the flexible waste water pipes may be separate such that they are interconnected to overflow 10 and drain assemblies 30 prior to interconnection to a tee connector 54 that is interconnected to the main drain pipe 58. Alternatively, the vertical waste water pipe 62V may be interconnected to an overflow assembly 10, and the drain assembly 30 may be separately interconnected to a horizontal flexible pipe 62H. Any excess may be cut from the other ends of the flexible waste water pipes prior to interconnection to the tee connector 54.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A bathtub waste pipe assembly for draining fluid from a bathtub where the bathtub has an upper overflow port at an upper end of the bathtub and a drain port on the bottom of the bathtub, comprising:
a first connector adapted to be secured to and in communication with the upper overflow port;
a second connector adapted to be secured to and in communication with the drain port; and
a flexible pipe connected between said first connector and said second connector, said flexible pipe being devoid of a valve operating mechanism.

2. The assembly of claim 1 wherein said flexible pipe has a generally non-corrugated inner surface.

3. The assembly of claim 1 wherein said first connector is an overflow assembly.

4. The assembly of claim 1 wherein said second connector is a drain assembly.

5. The assembly of claim 1 wherein said first connector includes an end adapted to extend through the bathtub.

6. The assembly of claim 5 further comprising a diaphragm sealed to the end of the first connector.

7. An assembly for removing waste fluid from a bathtub, comprising:
an upper connector adapted for interconnection to an overflow port of the bathtub;
a lower connector adapted for interconnection to a drain port of the bathtub; and
a flexible tube that fluidically interconnects said first connector to said second connector.

8. The assembly of claim 7, wherein said first connector is an overflow assembly and said second connector is a drain assembly.

9. The assembly of claim 7, wherein said first connector is in communication with the overflow port and said second connector is a tee connector that is in communication with the drain port and a main drain pipe of a dwelling.

10. The assembly of claim 9 wherein said overflow assembly includes an end that is adapted to be located within said bathtub, said end having a selectively removable diaphragm.

11. The assembly of claim 7 wherein said flexible tube is comprised of a flexible vertical segment and a flexible horizontal segment, wherein said flexible vertical segment is interconnected between said first connector and a third connector and said flexible horizontal connector is interconnected between said third connector and said second connector.

12. The assembly of claim 11, wherein said first connector is an overflow assembly, said second connector is a drain assembly and said third connector is a tee connector that is also adapted for interconnection to a main drain pipe.

13. The assembly of claim 7 wherein said flexible pipe has an inner diameter with a generally smooth surface.

14. The assembly of claim 7 wherein said flexible pipe is an assembly comprising a helical coil coated by a flexible material.

15. The assembly of claim 7 wherein said flexible tube has an inner surface that is generally devoid of depressions suitable for bacteria and or mold to accumulate within.

16. A method of installing a bathtub waste pipe assembly for draining fluid from a bathtub where the bathtub has an upper overflow drain having a flange at one end of the bathtub and a lower drain on the bottom of the bathtub, comprising:
securing a first connector end to and in communication with the upper overflow drain;
securing a second connector to and in communication with the lower drain;
connecting a flexible pipe that is devoid of a valve operating mechanism extending through the hollow tube; and
connecting the hollow tube to the second connector

17. The method of claim 16 further comprising the step of extending an end of a first connector through the bathtub.

18. The method of claim 16 further comprising the step of bending the hollow tube to adjust the length of the tube so as to fit between the first connector and the second connector.
